(19) United States
(12) Patent Application Publication
(10) Pub. No.: US 2024/0062107 A1
(43) Pub. Date: Feb. 22, 2024

(54) TRAINING OF A MACHINE LEARNING MODEL

(71) Applicant: Telefonaktiebolaget LM Ericsson (publ), Stockholm (SE)

(72) Inventors: Farnaz MORADI, Bromma (SE); Andreas JOHNSSON, Uppsala (SE); Jalil TAGHIA, Stockholm (SE); Hannes LARSSON, Solna (SE)

(21) Appl. No.: 18/269,734

(22) PCT Filed: Dec. 28, 2020
(86) PCT No.: PCT/EP2020/087918

§ 371 Date: Jun. 26, 2023

(51) Int. Cl. G06N 20/00

(52) U.S. Cl. CPC G06N 20/00

(57) ABSTRACT

A method by a client computing device having one or more sensors for collecting data, includes obtaining information identifying a first set of measurable features, each feature being associated with a measurement specification. For each feature of the first set of measurable features, determining whether there is at least one sensor of the one or more sensors satisfying the associated measurement specification. If there is at least one sensor of the one or more sensors satisfying the associated measurement specification, estimating a resource usage. Determining a first subset of the first set of measurable features and sending information identifying the first subset of the first set of measurable features. When the client computing device is determined to belong to the first group of computing devices, performing training of the machine learning model using the first group of computing devices.

### TECHNICAL FIELD

Embodiments presented herein relate to methods, computing devices, a computer program, a computer program product and a carrier for training of a machine learning model.

### BACKGROUND

In recent years, the number of internet-connected computing devices, referred to as Internet of Things (IoT) is growing and a large amount of data is being generated. To analyze these large amounts of data efficiently is important for developing smart IoT applications. Various machine learning (ML) methods have been proposed to process large amounts of data in an intelligent way, such as allowing the IoTs to learn from each other in a collaborated way.

However, there are challenges to train machine learning models for IoT devices. One challenge is that IoT devices may be constrained devices having limited resources (e.g. central processing unit (CPU), memory, battery) for data collection and for training ML models. Another challenge is that IoT devices may be heterogeneous with respect to computation capability, communication capabilities, storage etc., and they may run different operating systems and software with different configurations for data measurement. These differences may negatively affect the ML models which are trained collaboratively. Nishio, T. and Yonetani, R., “Client selection for federated learning with heterogeneous resources in mobile edge, 2019, ICC 2019-2019 IEEE International Conference on Communications (ICC), https://arxiv.org/pdf/1804.08333.Pdf, mentioned the problem of using federated learning in a heterogenous environment where some clients (i.e. client computing devices) with limited computational resources will require longer time to update models. Moreover, clients which suffer from poor wireless channel conditions will result in longer update time. All such problems will delay the subsequent server's aggregation step necessary to continue the training process. Nishio and Yonetani propose a solution in which the server can select the clients which can finish a specific task before a deadline. However, one purpose of using federated learning is preserving privacy, and the resource status of the clients should also be kept private.

### SUMMARY

According to a first aspect of the invention there is presented a method performed by a client computing device of a plurality of computing devices configured to perform training of a machine learning model. The client computing device comprises one or more sensors for collecting data. The method comprises obtaining information identifying a first set of measurable features from a coordinating computing device of the plurality of computing devices, each feature of the first set of measurable features being associated with a measurement specification for collecting data corresponding to the feature. The method further comprises for each feature of the first set of measurable features, determining whether there is at least one sensor of the one or more sensors satisfying the associated measurement specification for collecting data corresponding to the feature. The method further comprises if there is at least one sensor of the one or more sensors satisfying the associated measurement specification, estimating a resource usage by each of the at least one sensor for collecting data corresponding to the feature. The method further comprises determining a first subset of the first set of measurable features, wherein the at least one sensor of the one or more sensors is selected for collecting data corresponding to the first subset of the first set of measurable features based on the estimated resource usage. The method further comprises sending information identifying the first subset of the first set of measurable features to the coordinating computing device. The method further comprises obtaining information from the coordinating computing device whether the client computing device belongs to a first group of computing devices of the plurality of computing devices; and if the client computing device belongs to the first group of computing devices, performing training of the machine learning model using the first group of computing devices.

According to a second aspect of the invention there is presented a method performed by a coordinating computing device of a plurality of computing devices configured to perform training of a machine learning model. The method comprises sending information identifying a first set of measurable features to a client computing device of the plurality of computing devices. The method comprises obtaining information identifying a first subset of the first set of measurable features from the client computing device, wherein the client computing device comprises one or more sensors, and the first subset of the first set of measurable features have associated measurement specifications for collecting data corresponding to the features, which measurement specifications are satisfied by at least one of the one or more sensors based on an estimated resource usage associated with the at least one of the one or more sensors. The method further comprises determining if the client computing device belongs to a first group of computing devices based on the first subset of the first set of measurable features.

According to a third aspect of the invention there is presented a client computing device of a plurality of computing devices configured to perform training of a machine learning model. The client computing device comprises one or more sensors for collecting data. The client computing device comprises processing circuitry causing the computing device to be operative to obtain information identifying a first set of measurable features from a coordinating computing device of the plurality of computing devices, each feature of the first set of measurable features being associated with a measurement specification for collecting data corresponding to the feature. The client computing device is further configured to for each feature of the first set of measurable features, determine whether there is at least one sensor of the one or more sensors satisfying the associated measurement specification for collecting data corresponding to the feature. The client computing device is further configured to if there is at least one sensor of the one or more sensors satisfying the associated measurement specification, estimate a resource usage by each of the at least one sensor for collecting data corresponding to the feature. The client computing device is further configured to determine a first subset of the first set of measurable features, wherein the at least one sensor of the one or more sensors is selected for collecting data corresponding to the first subset of the first set of measurable features based on the estimated resource usage. The client computing device is further configured to send information identifying the first subset of the first set of measurable features to the coordinating computing device. The client computing device is further configured to obtain information from the coordinating computing device whether the client computing device belongs to a first group of computing devices of the plurality of computing devices; and if the client computing device belongs to the first group of computing devices, perform training of the machine learning model using the first group of computing devices.

According to a fourth aspect of the invention there is presented a coordinating computing device of a plurality of computing devices configured to perform training of a machine learning model. The coordinating computing device comprises processing circuitry causing the computing device to be operative to send information identifying a first set of measurable features to a client computing device of the plurality of computing devices. The coordinating computing device is further configured to obtain information identifying a first subset of the first set of measurable features from the client computing device, wherein the client computing device comprises one or more sensors, and the first subset of the first set of measurable features have associated measurement specifications for collecting data corresponding to the features, which measurement specifications are satisfied by at least one of the one or more sensors based on an estimated resource usage associated with the at least one of the one or more sensors. The coordinating computing device is further configured to determine if the client computing device belongs to a first group of computing devices based on the first subset of the first set of measurable features.

According to a fifth aspect of the invention there is presented a computer program comprising instructions which, when executed on a processing circuitry, cause the processing circuitry to perform a method according to the first aspect and the second aspect.

According to a sixth aspect of the invention there is presented a computer program product comprising a computer readable storage medium on which a computer program according to the fifth aspect, is stored.

According to a seventh aspect of the invention there is a carrier containing the computer program according to the fifth aspect, wherein the carrier is one of an electronic signal, an optical signal, a radio signal, and a computer readable storage medium.

Advantageously, these aspects provide an efficient way of training machine learning models in an environment with heterogenous devices, without revealing information about resource status of the heterogenous devices.

Advantageously, these aspects provide a flexible way to reconfigure heterogenous devices for training machine learning models. The heterogenous devices may adapt their settings dynamically and reach an agreement about which kind of data may be collected for the corresponding features.

Other objectives, features and advantages of the enclosed embodiments will be apparent from the following detailed disclosure, from the attached independent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 illustrates a computing environment comprising IoT devices according to some embodiments herein;

FIG. 2 is a flowchart of a method performed by a client computing device for machine learning according to some embodiments herein;

FIG. 3 is a flowchart of a method performed by a coordinating computing device for machine learning according to some embodiments described herein;

FIG. 4 illustrates a high-level architecture of the proposed solution of federated learning according to some embodiments described herein;

FIG. 5 is a flowchart illustrating a method performed by a client computing device that has subscribed to the training of a federated learning model according to some embodiments described herein;

FIG. 6 schematically illustrates a client computing device for machine learning according to some embodiments described herein; and

FIG. 7 shows an embodiment of a computer program product comprising computer readable storage medium according to some embodiments described herein.

### DETAILED DESCRIPTION

The present invention will now be described more fully hereinafter. The present invention may, however, be embodied in many different forms and should not be construed as limited to the embodiments set forth herein; rather, these embodiments are provided by way of example so that this disclosure will be thorough and complete, and will fully convey the scope of the invention to those persons skilled in the relevant art.

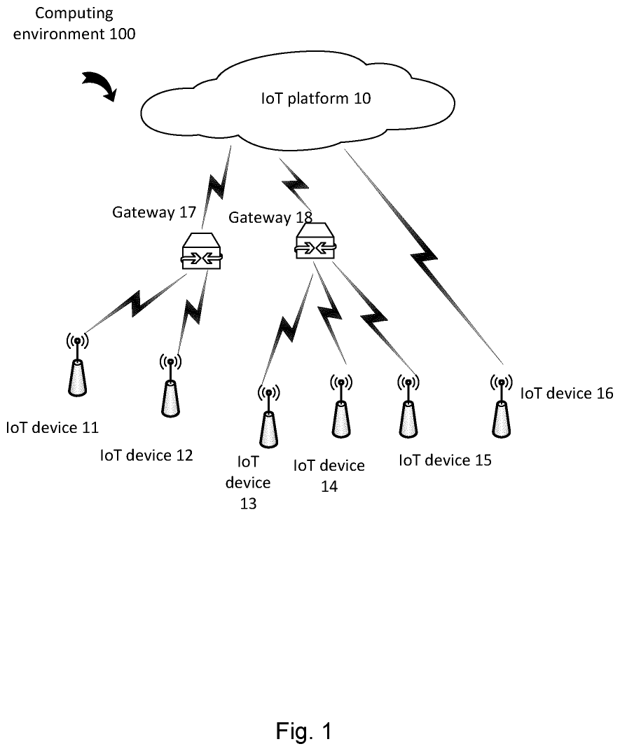

With reference to FIG. 1, a computing environment 100 comprising IoT devices is shown. The computing environment 100 may comprise IoT devices 11, 12, 13, 14, 15, 16, and gateways 17, 18. The IoT platform 10 collects data from IoT devices and gateways. Data feeds or data streams are data generated by IoT devices, i.e., sensors, and transmitted to the IoT platform. The data feeds can have metadata, attributes and features associated to them. The IoT platform 10 may use cloud computing capacities for provision and support of real-time applications and services for different needs. It is challenging to analyse the considerable amounts of data produced from heterogeneous, distributed/decentralized devices since data may not be able to be uploaded to a central venue for model training, due to their large volumes and/or security/privacy concerns.

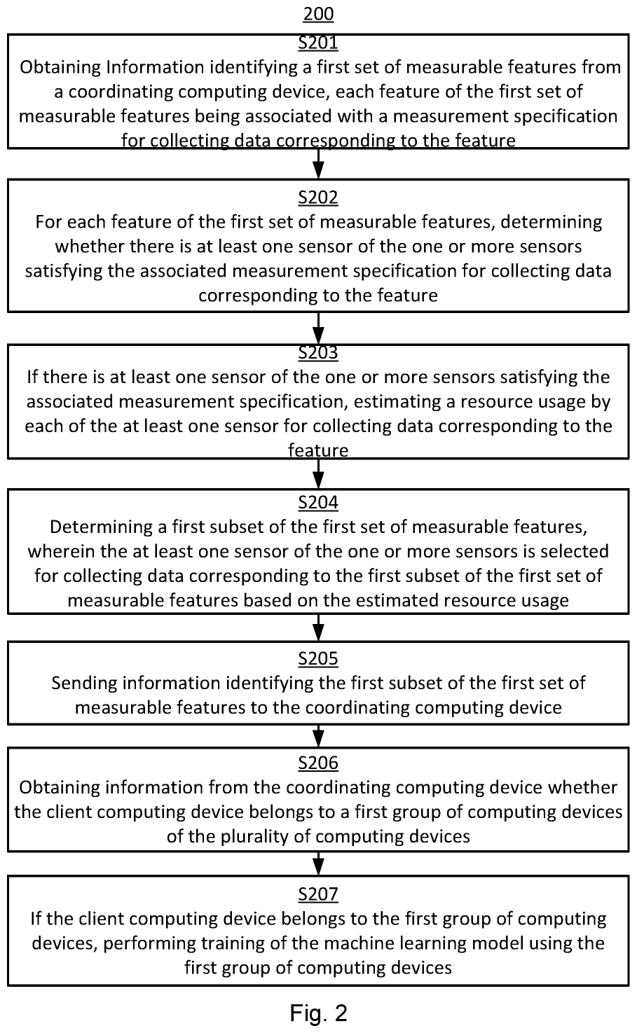

FIG. 2 shows a method 200 performed by a client computing device of a plurality of computing devices configured to perform training of a machine learning model according to some embodiments described herein. The client computing device comprises one or more sensors for collecting data. The method is advantageously provided as a computer program 720.

S201: The method 200 comprises obtaining information identifying a first set of measurable features from a coordinating computing device of the plurality of computing devices, each feature of the first set of measurable features being associated with a measurement specification for collecting data corresponding to the feature. Notice that in this application, obtaining a first set of measurable features means obtaining information identifying a first set of measurable features. A measurement specification specifies a measurement requirement in a quantitative way.

In some embodiments, the obtaining information identifying a first set of measurable features further comprises obtaining the measurement specification for each feature of the first set of features. In some embodiments, the measurement specification for each feature of the first set of features is stored locally in the client computing device. In some other embodiments, the measurement specification for each feature of the first set of features is stored centrally in a repository and may be requested. In some embodiments the stored measurement specification may be updated by a triggering event. In some other embodiments the stored measurement specification may be updated periodically or occasionally.

In some embodiments, the measurement specification for each feature of the first set of features is at least one of: data sampling frequency, data resolution, data accuracy, data measurement unit, and a value range of the feature. For example, if the feature is temperature, the associated measurement specification for temperature may specify whether temperature is sampled every second or every 10 seconds. The data resolution may specify a temperature resolution of 0.125° C. The data measurement unit may specify if Celsius or Fahrenheit definition is used. The value range of the feature may specify that the range of temperature is between −200° C. to 600° C..

In some embodiments, the plurality of computing devices is heterogeneous in terms of at least one of: sensor configuration, sensor availability, radio communication capabilities, network capabilities, execution environment, software version, systematic noise and interferences, existence of stochastic noise and interferences, measurement capabilities, storage capabilities, battery capacities, and compute capabilities.

In some embodiments, each feature of the first set of measurable features is a feature representing a property of a physical environment.

In some embodiments, a feature representing a property of a physical environment is at least one of: temperature, light, acceleration, sound intensity, altitude, humidity, moisture, weather data, and positioning information.

S202: The method 200 comprises for each feature of the first set of measurable features, determining whether there is at least one sensor of the one or more sensors satisfying the associated measurement specification for collecting data corresponding to the feature.

In some embodiments, the step of determining whether there is at least one sensor of the one or more sensors satisfying the associated measurement specification for collecting data corresponding to the feature further comprises adjusting a configuration of the at least one sensor of the one or more sensors to satisfy the feature's measurement specification. In some embodiments the adjustment of the configuration may be performed dynamically.

S203: The method 200 comprises if there is at least one sensor of the one or more sensors satisfying the associated measurement specification, estimating a resource usage by each of the at least one sensor for collecting data corresponding to the feature.

S204: The method 200 comprises determining a first subset of the first set of measurable features, wherein the at least one sensor of the one or more sensors is selected for collecting data corresponding to the first subset of the first set of measurable features based on the estimated resource usage.

In some embodiments, the step of determining a first subset of the first set of measurable features further comprises at least one of: determining that the number of features in the first subset of the first set of measurable features is maximized, with a constraint that a sum of the corresponding estimated resource usage is below a threshold value; each feature of the first set of measurable features having a weight value indicating an importance of the feature, and determining that a sum of the corresponding estimated resource usage is weighted by the importance of each feature, with a constraint that the sum is below a threshold value. The client computing device may be a constrained device and it is important that the constraint with respect to resource usage is satisfied. Also, based on applications, a specific feature may be more important than other features, so that there is a trade-off between the resource usage for collecting data corresponding to the specific feature and the importance of the specific feature.

S205: The method 200 comprises sending information identifying the first subset of the first set of measurable features to the coordinating computing device. Notice that in this application, sending a first set of measurable features means sending information identifying a first set of measurable features.

S206: The method 200 comprises obtaining information from the coordinating computing device whether the client computing device belongs to a first group of computing devices of the plurality of computing devices.

In some embodiments, the step of obtaining information from the coordinating computing device whether the client computing device belongs to a first group of computing devices of the plurality of computing devices further comprises: if the client computing device belongs to the first group of computing devices, obtaining information identifying a second subset of the first set of measurable features, wherein the second subset of the first set of measurable features have associated measurement specifications for collecting data corresponding to the features, and wherein the measurement specifications are satisfied by each of the first group of computing devices. In some embodiments, the method further comprises collecting data corresponding to the features of the second subset of the first set of measurable features based on the features' measurement specifications. For example, the client computing device may obtain information identifying a first set of measurable features comprising temperature, light and humidity from the coordinating computing device. Each of the first group of computing device (including the client computing device) may collect data corresponding to temperature and humidity (which is a subset of the first set of measurable features) and satisfy the measurement specifications for temperature and humidity.

In some embodiments, the step of obtaining information from the coordinating computing device whether the client computing device belongs to a first group of computing devices of the plurality of computing devices further comprises: if the client computing device does not belong to the first group of computing devices, obtaining information identifying a second set of measurable features, wherein the second set of measurable features have associated measurement specifications for collecting data corresponding to the features, and wherein the measurement specifications are satisfied by a second group of computing devices. In some embodiments, the method further comprises for each feature of the second set of measurable features, determining whether there is at least one sensor satisfying the feature's measurement specification for collecting data corresponding to the feature; if there is at least one sensor satisfying the feature's measurement specification for collecting data corresponding to the feature, estimating a resource usage by each of the at least one sensor for collecting data corresponding to the feature; and determining whether to collect data corresponding to the features of the second set of measurable features based on the estimated resource usage for collecting data corresponding to features of the second set of measurable features.

In some embodiments, the determining whether to collect data corresponding to the features of the second set of measurable features further comprises: if a sum of the corresponding estimated resource usage is below a threshold value, collecting data corresponding to the features of the second set of measurable features based on the features' measurement specifications; and performing training of the machine learning model by the second group of computing devices.

S207: The method 200 comprises if the client computing device belongs to the first group of computing devices, performing training of the machine learning model using the first group of computing devices.

The proposed method enables heterogeneous client computing devices to setup and re-configure their data collection and measurement settings, so that the client computing devices can collaboratively train the machine learning model and benefit from data collected by other client computing devices without revealing about its local resource usage, its local configuration settings etc.

In some embodiments, the machine learning model is at least one of: a federated learning model, and a distributed collaborative learning model. The details of how to implement the method in these two machine learning models will be described further below.

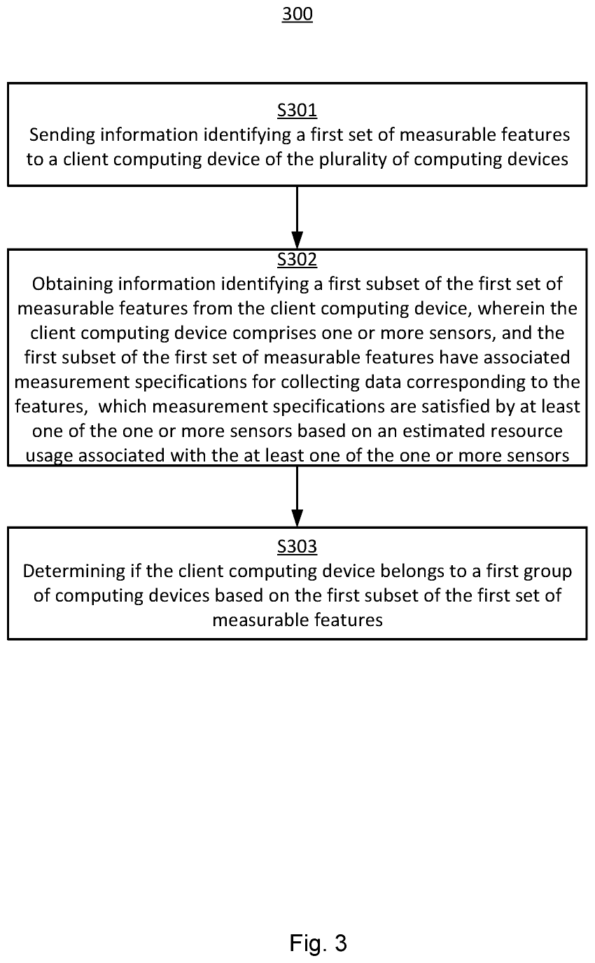

FIG. 3 shows a method 300 performed by a coordinating computing device of a plurality of computing devices configured to perform training of a machine learning model according to some embodiments described herein. The method is advantageously provided as a computer program 720. Notice that a computing device may be a client computing device, a server computing device, or a coordinating computing device depending on its implementation.

S301: The method 300 comprises sending information identifying a first set of measurable features to a client computing device of the plurality of computing devices.

In some embodiments the step of sending information identifying a first set of measurable features to a client computing device further comprises sending a measurement specification for each feature of the first set of features. In some embodiments, the measurement specification for each feature of the first set of features is stored in the coordinating computing device. In some other embodiments, the measurement specification for each feature of the first set of features is stored centrally in a repository and may be requested. In some other embodiments, the measurement specification for each feature of the first set of features is stored locally in the client computing device. In some embodiments the stored measurement specification may be updated by a triggering event. In some other embodiments, the stored measurement specification may be updated periodically or occasionally.

In some embodiments, the measurement specification for each feature of the first set of features is at least one of: data sampling frequency, data resolution, data accuracy, data measurement unit, and a value range of the feature.

In some embodiments, the plurality of computing devices is heterogeneous in terms of at least one of: sensor configuration, sensor availability, radio communication capabilities, network capabilities, execution environment, software version, systematic noise and interferences, existence of stochastic noise and interreferences, measurement capabilities, storage capabilities, battery capacities, and compute capabilities.

In some embodiments, each feature of the first set of measurable features is a feature representing a property of a physical environment.

In some embodiments, a feature representing a property of a physical environment is at least one of: temperature, light, acceleration, sound intensity, altitude, humidity, moisture, weather data, and positioning information.

S302: The method 300 comprises obtaining information identifying a first subset of the first set of measurable features from the client computing device, wherein the client computing device comprises one or more sensors, and the first subset of the first set of measurable features have associated measurement specifications for collecting data corresponding to the features, which measurement specifications are satisfied by at least one of the one or more sensors based on an estimated resource usage associated with the at least one of the one or more sensors.

S303: The method 300 comprises determining if the client computing device belongs to a first group of computing devices based on the first subset of the first set of measurable features.

In some embodiments, the determining if the client computing device belongs to a first group of computing devices further comprises: if the computing device does not belong to the first group of computing devices, sending information identifying a second set of measurable features, wherein the second set of measurable features have associated measurement specifications, which measurement specifications are satisfied by a second group of computing devices.

In some embodiments, the determining if the client computing device belongs to a first group of computing devices further comprises: if no group can be found for the client computing device, notifying the client computing device that it is not able to participate in training of the machine learning model.

In some embodiments, the determining if the client computing device belongs to a first group of computing devices further comprises: if the client computing device belongs to the first group of computing devices, sending information identifying a second subset of the first set of measurable features wherein the second subset of the first set of measurable features have associated measurement specifications, which measurement specifications are satisfied by each of the first group of computing devices.

In some embodiments the machine learning model is a federated learning (FL) model. The coordinating computing device is such a server computing device that is responsible for determining the grouping of client computing devices and generating a federated machine learning model. In some embodiments the machine learning model is a distributed collaborative learning model. The coordinating computing device is such a client computing device that determines the grouping of client computing devices together with other computing devices.

Federated Learning Scenario:

The algorithm presented by Google, named “FederatedAveraging” (McMahan et al., “Federated Learning of deep networks using model averaging”, arXiv: 1602.05629, 2016), has led to the coining of the term “federated learning”. This algorithm addresses several real-world challenges: the ability to handle unbalanced and non-IID (independent and identically distributed) data, massively distributed data (where there are more devices than the average number of data samples that can be used for training per device), as well as reductions in communication needed for training.

In the FederatedAveraging algorithm, a server (may also be named as a leader node) first initializes the weights of a neural network model. For every training round, the server sends the model weights to a fraction of client devices (may also be named as worker nodes) that are available to take part of the training, and the client devices return their evaluation of the model performance. Each client being part of the training initialises a local copy of the neural network model with the received weights and runs one or more epochs (where 1 epoch=1 forward pass+1 backward pass for all available training samples), resulting in a set of updated weights. The client then returns some evaluation of how the model performed along with some indication of the updated weights, for example the difference between the weights received from the server and the updated weights. The server can then decide how to update the model to increase its performance.

In federated learning, due to privacy concerns, in addition to not sharing training data, preferably the client computing devices should not share any information about their resource constraints, operating systems, software versions, sensor configurations for data collection, etc.

In some embodiments, the client computing devices setup and configure/re-configure their measurement settings to collect measurable features specified by the server computing device based on available sensors and their available configurations and local constraints. Each client computing device may comprise one or more sensors that can be configured in different ways. Each of the one or more sensors may satisfy specific measurement specifications. Each of the client computing devices may report to the server computing device its measurable features which may be a subset of the measurable features specified by the server computing device. The server computing device may group the client computing devices by identifying a group of client computing devices that are able to collect data corresponding to similar measurable features. The client computing devices which are not assigned to a group may decide to re-configure their sensors in order to be able to join a federation group with other client computing devices if it is possible.

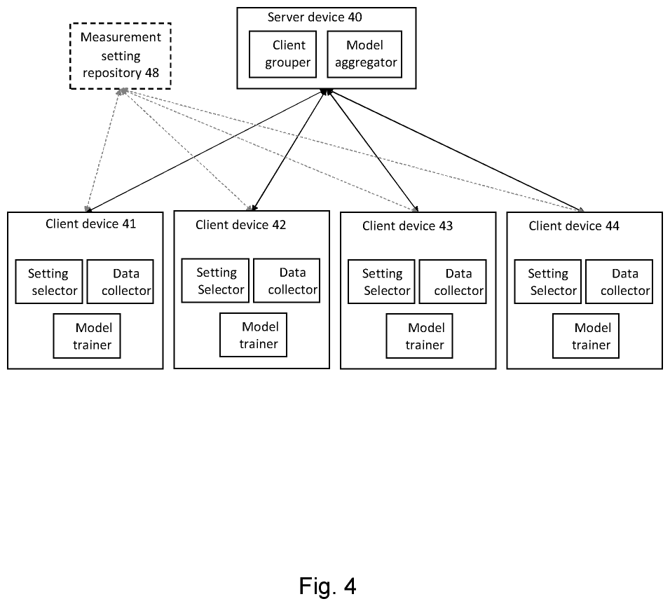

FIG. 4 illustrates a high-level architecture of the proposed solution of federated learning. The computing environment comprises server computing device 40, and client computing devices 41, 42, 43, 44 configured to perform training of a federated learning model. Note that the server computing device 40 (i.e., a leader node) may be a server, a gateway in a data center, or may be one of the existing client computing devices (i.e., work nodes) which has taken the role of a server computing device. Each client computing device 41, 42, 43, 44 may comprises one or more sensors for collecting data.

The server computing device 40 may perform two main functions: Client grouper and Model aggregator. Notice that for illustration purpose these two main functions are shown as two separate modules but there is no limitation if the functions should be implemented by several modules or one single module. The Client grouper decides which client computing devices may participate in training a FL model based on the measurable features that can be collected/measured by the client computing devices. Optionally the Client grouper may send information identifying a first set of measurable features to all client computing devices 41, 42, 43, 44 of the plurality of computing devices. Optionally the Client grouper may send information identifying the first set of measurable features to part of the client computing devices of the plurality of computing devices. Which measurable features are sent may be different depending on use cases. Optionally the Client grouper may send a measurement specification for each feature of the first set of measurable features together with the first set of measurable features. For example, a measurable feature may be temperature and the measurement specification for temperature is defined as a value range of the measurable feature, that is −200° C. to 600° C. The Client grouper may receive from each client computing device a subset of the first set of measurable features. The Client grouper may group the client computing devices based on several factors, for example, size of a group for federated training, number of measurable features, etc.

The Model aggregator may be responsible for initiating FL and running e.g., FederatedAveraging algorithm, to aggregate model weights from the client computing devices participating in FL. The Model aggregator may send the aggregated/updated model weights to all client computing devices participating in FL.

Each of the client computing device 41, 42, 43, 44 may perform three main functions: Setting selector, Data collector, and Model trainer. Notice that for illustration purpose these three main functions are shown as three separate modules but there is no limitation if the functions should be implemented by several modules or one single module. The Setting selector is responsible for identifying which sensor(s) may be deployed and configured locally (i.e. within the client computing device) in order to generate the measurable features required for federated learning. The function of Setting selector may also obtain information about available local resources (e.g., CPU, memory, energy within the client computing device). If there is at least one sensor satisfying a feature's measurement specification for collecting data corresponding to the feature, a resource usage associated with the at least one sensor for collecting data corresponding to the feature is subsequently estimated. The estimated resource usage corresponding to the at least one sensor is used as a criterion to select the optimal setting to be deployed and (re-)configured locally. The Setting selector function may send the first subset of the first set of measurable features to the server computing device 40. The first subset of the first set of measurable features is/are feature(s) that is/are able to be measured/collected at the client computing device 41, 42, 43, 44 while satisfying the criterion for resource usage. In some embodiments the Setting selector may select a sensor satisfying a measurement specification that is within a pre-defined range to the measurement specification defined by the server computing device 40. Using the example mentioned above, a sensor with temperature measure range −180° C. to 600° C. may still be selectable since the available measurement range is close to the defined measurement range of −200° C. to 600° C. In other words, it may be allowed if the differences of available measurement ranges from the specified measurement ranges are within a pre-defined threshold. In this way, a certain flexibility is introduced so that the sensor satisfying a similar measurement specification as that defined by the server computing device 40 may be selected.

The Data collector is responsible for collecting data using the selected sensor(s). The collected data is then used by a local Model trainer which is responsible for training the FL model locally and sharing the model weights with the server computing device 40.

As illustrated in FIG. 4, the embodiment may optionally include a Measurement setting repository 48. The Measurement setting repository may store information relating to a mapping of measurable features to different sensors, measurement software, configurations and the corresponding estimated resource usages, etc. This mapping information may be pre-defined by a domain expert or automated by a machine learning algorithm based on historical data. The resource usage may be estimated by benchmarking where resource usage (in terms of energy, memory, CPU circle, communication cost, etc) is measured for different combinations of sensor and sensor configurations in order to predict future resource usages. Other suitable machine learning method may also be used. In some embodiments the Measurement setting repository 48 may store measurement specification for each measurable feature.

The Measurement setting repository 48 may be accessible by the function of Setting selector of each client computing device 41, 42, 43, 44 in order to identify which settings satisfy the measurement specification for collecting data corresponding to the measurable features, and what are the corresponding estimated resource usages etc. The Measurement setting repository 48 may be in a centralized location or distributed so that each client computing device may have access to its own local Measurement setting repository.

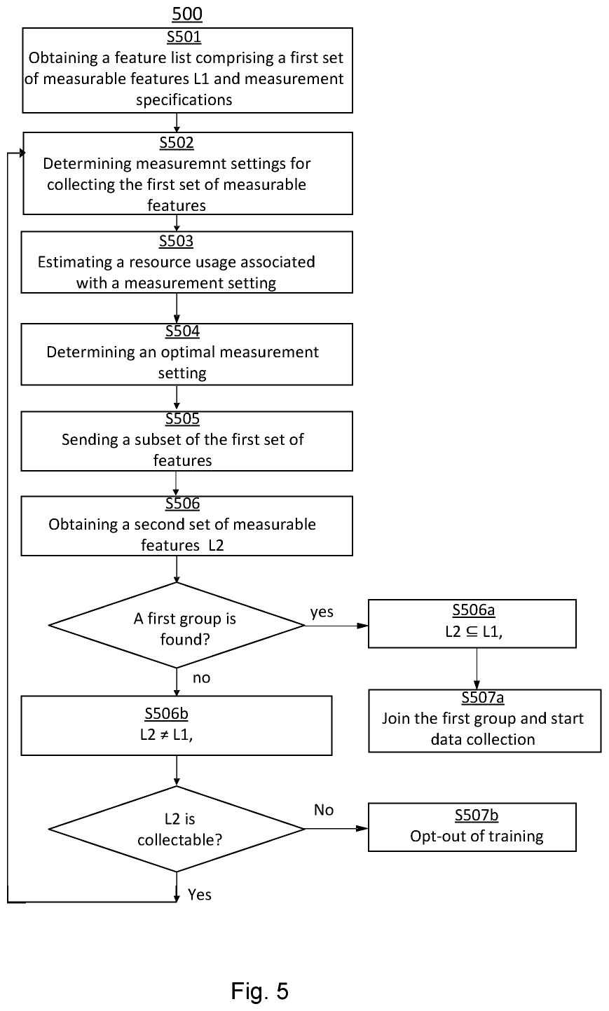

FIG. 5 is a flowchart illustrating a method 500 performed by a client computing device that has subscribed to the training of a federated learning model according to some embodiments described herein. At step S501, the method comprise obtaining information identifying a feature list comprising a first set of measurable features, that is L1=[f1, f2, . . . , fn], (e.g., f1=temperature, and f2=throughput), and a measurement specification associated with each feature of the first set of measurable features from the server computing device (e.g., f1 should be measured every 1 min), f2 should be measured every 1 sec). Notice that obtaining information identifying a feature list means the same thing as obtaining a feature list.

At step S502, for each feature f1 (1<i<n), the method comprises determining the data collection/measurement settings that are available and can be deployed and configured for collecting the data corresponding to the list of measurable features. As mentioned above, this information about mapping the measurable features and measurement specifications to a specific sensor(s) and the corresponding configurations may be stored in a Measurement setting depository that can be located externally in a data center or locally in a client computing device.

At step S503, the method comprising estimating/identifying a resource usage associated with deployment of each measurement setting for each of the measurable features. In other words, the same measurable feature may be collected/measured using different settings, for example different measurement sensors may be used, and for each sensor, different configurations and/or protocols may be used so that the corresponding resource usage may be different. In some embodiments, this information relating to estimated resource usage corresponding to each measurable feature with different settings may also be stored in a Measurement setting depository.

One example of how the mapping between measurable features (and their measurement specifications) and measurement settings is constructed is shown in Table 1 below.

TABLE 1
Mapping table for measurable features

| Feature, | | | |
|---|---|---|---|
| measurement | Measurement | Config- | Resource |
| specification | sensor | uration | requirements |
| F1, M1 | S1 | C1 | CPU: x1, Mem: y1, . . . |
| F1, M1 | S1 | C2 | CPU: x2, Mem: y1, . . . |
| F1, M1 | S2 | C3 | CPU: x3, Mem: y3, . . . |
| F2, M2 | S3 | C4 | CPU: x4, Mem: y4, . . . |
| F3, M3 | S3 | C5 | CPU: x5, Mem: y5 |
| F4, M4 | — | — | — |
| . . . | . . . | . . . | . . . |

As it can be seen from Table 1, for feature F1 with measurement specification M1, two different sensors S1 and S2 may be used, and for sensor S1, two different configurations C1 and C2 are available for satisfying the measurement specification M1 of this feature F1. For feature F1, totally there are three different configurations C1, C2 and C3 available that satisfy the measurement specification M1. The corresponding estimated resource usages (e.g. CPU usage and memory resources) may thus be different. For measurable feature F4 with measurement specification M4, it is shown that no sensor and configuration satisfy the feature's measurement specification. In other words, feature F4 cannot be collected/measured by the client computing device. In some embodiments, the measurement specification for each feature of the features in the feature list may be obtained from the server computing device. In some embodiments the measurement specification for each feature of the features in the feature list may be obtained from a Measurement setting repository which is located locally in the client computing device or centrally. In some embodiments the measurement specification for each feature of the features in the feature list has default values. In some embodiments the measurement specification for each feature of the features in the feature list is updated by a triggering event or by a pre-defined time period. In some embodiments the resource constraint of different configurations is estimated based on historical data or benchmarking.

At step S504, the method comprises determining an optimal measurement setting that can be deployed for collecting data needed for measuring the features in the feature list. The client computing device is a resource constrained device and has a budget for how much resources it may use for data collection (e.g., specified percentage of available CPU, memory, battery etc.). A simple objective is to cover as many features in the feature list as possible while satisfying the client computing device's resource constraint. An alternative approach is to define an objective that takes into account both the importance of each feature and its resource usage into account. Optionally the importance of each feature may be pre-defined by the server computing device. It may also be defined by the client computing device. Optionally the importance of each feature may be dynamically updated.

At step S505, the method comprises sending information identifying a subset of the first set of features that are collectable at the client computing device to the server computing device, e.g., [f1, f3, . . . , fk] (o<k<n). Notice that sending information identifying a subset of the first set of features means the same thing as sending a subset of the first set of features.

At step S506, the method comprises obtaining response from the server computing device comprising a second set of measurable features L2. Optionally there are two alternative situations.

At step S506a, a first group is found for the client computing device based on the subset of the list of features sent, and the second set of measurable features is overlapping features (i.e., common features) shared by the first group of client computing devices. In this case, L2 ⊆L1.

Following step S506a, at step S507a, the method comprises deploying the optimal setting for collecting data corresponding to the second set of measurable features L2, starting data collection, and preparing for local FL model training. Optionally the method comprises reconfiguring the measurement setting so that the reconfigured setting satisfies the measurement specification of the second set of measurable features L2.

At an alternative step S506b, no group is found for the client computing device based on the subset of the list of features sent. The second set of measurable features L2 is thus overlapping features (i.e., common features) shared by a second group of client computing devices that the client computing device may potentially join. In this case, L2≠L1.

Following step S506b, it is determined if the second set of measurable features shared by the second group is collectable at the client computing device. If the second set of features cannot be collected due to resource restrictions or availability of sensors, configurations, protocols etc., (for example, no compatible configuration is available for collecting any feature of this second set of features), at step S507b, the client computing device may opt-out of the training. Otherwise the method may return to step S502 to find updated measurement settings based on this second set of features L2 sent by the server computing device.

In some embodiments, the server computing device, after receiving the measurable feature(s) from each client computing devices, may group the client computing devices into groups based on the common/overlapping measurable features the client computing devices within a group can measure. In some embodiments a criterion for grouping is that each group has a pre-defined minimum number of required client computing devices. The server computing device may then initialize a federated learning process by creating a model (e.g., a neural network) with selected measurable features as input and random model parameters.

Note that the server computing device does not acquire information about local settings of each client computing device for data collection. It only uses measurable features for grouping. This type of grouping is different from existing methods which either use information about data distribution of each client computing device or the knowledge about available resources for each client computing devices. Moreover, the federated learning model is created with the measurable features selected by the client computing devices instead of the original set of features proposed by the server computing device, which provides a federated learning model that is personalized for the group of client computing devices participating in the training process.

In some embodiments a client computing device may participate in training of multiple machine learning models (locally or collaboratively), which means that the client computing device needs to consider requirement for all the participated machine learning models in order to find the optimal set of measurement settings to be deployed locally. For example, if a measurement configuration C1 is used for collecting feature F1 with a sampling frequency M1 (as measurement specification) for training a machine model Model1, when the client computing device wants to participate in training a machine model Model2 that requires the same feature F1 but with a different sampling frequency M2 (as measurement specification), the client computing device may decide to configure the measurement setting with a configuration that is suitable for both ML models to keep the resource usage below the given budget. For example, the client computing device may configure its measurement setting to collect data every 1 second for the machine learning model Model1 but use an aggregate value every 5 seconds to create the same feature F1 for the machine learning model Model2 with a different measurement specification.

Distributed Collaborative Learning Scenario:

For distributed collaborative learning, the proposed method is performed by client computing devices (i.e. worker nodes) without a need for a centralized server computing device (i.e. leader node). For collaborative learning among a plurality of client computing devices, the client computing devices agree on a set of common measurable features. In some embodiments each client computing device determines locally which measurement setting it can setup depending on available sensors, configurations and its resource constraints etc. The set of measurable features from each client computing device may be shared with other client computing devices. In some embodiments, each client computing device decide locally to form a group with which other client computing devices. In some embodiments if a client computing device is not able to find any other client computing device with a similar set of measurable features, the client computing device has to either opt-out of collaborative learning, or reconfigure its local measurement settings and try to join one of the potential groups.

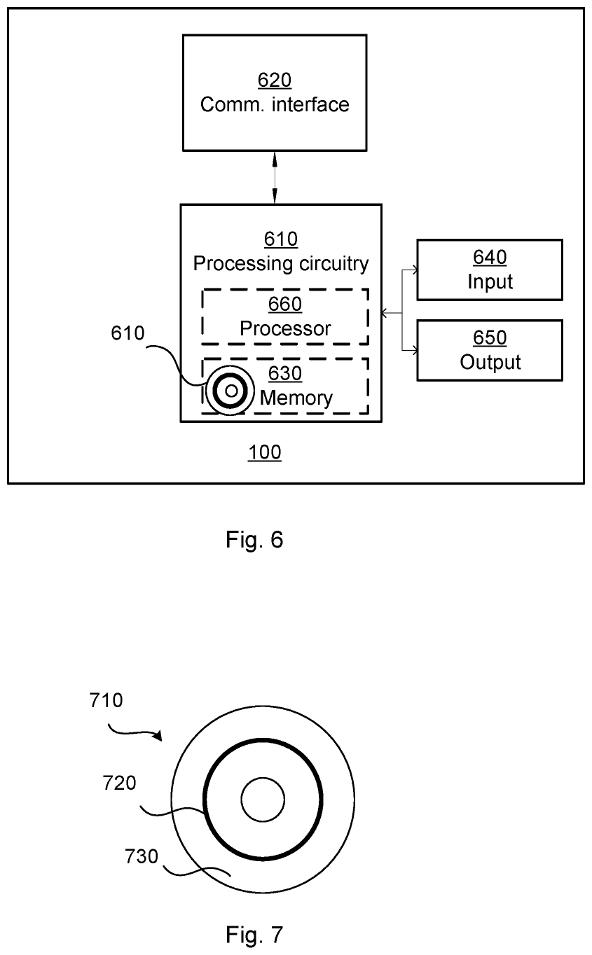

FIG. 6 schematically illustrates a computing device according to some embodiments described herein. Since a coordinating computing device is a type of computing device with the function of coordinating among the computing devices, the coordinating computing device can be illustrated in the same way. A client computing device may also be illustrated in the same way. Processing circuitry 610 is provided using any combination of one or more of a suitable central processing unit (CPU), multiprocessor, microcontroller, digital signal processor (DSP), etc. The processing circuitry 610 may comprises a processor 660 and a memory 630 wherein the memory 630 contains instructions executable by the processor 660. The memory 630 may further contain the computer program product 710 (as shown in FIG. 7). The processing circuitry 610 may further be provided as at least one application specific integrated circuit (ASIC), or field programmable gate array (FPGA). The computing device may comprise input 640 and output 650. The input 640 may receive data to sensors for different measurement purpose. Th input 640 may receive information from other computing devices. The output 650 may output information to other computing devices.

The computing device may further comprise a communication interface 620. The communication interface 620 may implement different communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standard.

The processing circuitry 610 is thereby arranged to perform methods as herein disclosed. The memory 630 may also comprise persistent storage, which, for example, can be any single one or combination of magnetic memory, optical memory, solid state memory or even remotely mounted memory.

Examples of a computing device include, but are not limited to, a smartphone, a mobile phone, a cell phone, a voice over IP (VoIP) phone, a wireless local loop phone, a desktop computer, a personal digital assistant (PDA), a wireless camera, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. In some embodiments the computing device is an IoT device. An IoT device can be a constrained device with a specific purpose. IoT devices may include, but are not limited to, refrigerators, ovens, microwave ovens, refrigerators, dishwashers, tableware, hand tools, washing machines, clothes dryers, ovens, air conditioners, thermostats, televisions, lamps, vacuum cleaners, sprinklers, electricity meters, gas meters, etc., as long as the device is equipped with an addressable communication interface for communicating within a network.

FIG. 7 shows one example of a computer program product 710 comprising computer readable storage medium 730. On this computer readable storage medium 730, a computer program 720 can be stored, which computer program 720 can cause the processing circuitry 610 and thereto operatively coupled entities and devices, such as the communications interface 620, to execute methods according to embodiments described herein. The computer program 720 and/or computer program product 710 may thus provide means for performing an embodiment of the methods disclosed herein.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710. A carrier may contain the computer program 620, wherein the carrier is one of an electronic signal, an optical signal, a radio signal, and a computer readable storage medium 730.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method performed by a client computing device of a plurality of computing devices configured to perform training of a machine learning model, the client computing device comprising one or more sensors for collecting data, the method comprising:
obtaining information identifying a first set of measurable features from a coordinating computing device of the plurality of computing devices, each feature of the first set of measurable features being associated with a measurement specification for collecting data corresponding to the feature;
for each feature of the first set of measurable features, determining whether there is at least one sensor of the one or more sensors satisfying the associated measurement specification for collecting data corresponding to the feature;
if there is at least one sensor of the one or more sensors satisfying the associated measurement specification, estimating a resource usage by each of the at least one sensor for collecting data corresponding to the feature;
determining a first subset of the first set of measurable features, wherein the at least one sensor of the one or more sensors is selected for collecting data corresponding to the first subset of the first set of measurable features based on the estimated resource usage;
sending information identifying the first subset of the first set of measurable features to the coordinating computing device;
obtaining information from the coordinating computing device whether the client computing device belongs to a first group of computing devices of the plurality of computing devices; and
if the client computing device belongs to the first group of computing devices, performing training of the machine learning model using the first group of computing devices.

2. The method according to claim 1, wherein the obtaining information identifying a first set of measurable features further comprises obtaining the measurement specification for each feature of the first set of features.

3. The method according to claim 1, wherein the measurement specification for each feature of the first set of features is at least one of: data sampling frequency, data resolution, data accuracy, data measurement unit, and a value range of the feature.

4. The method according to claim 1, wherein the plurality of computing devices is heterogeneous in terms of at least one of: sensor configuration, sensor availability, radio communication capabilities, network capabilities, execution environment, software version, systematic noise and interferences, existence of stochastic noise and interferences, measurement capabilities, storage capabilities, battery capacities, and compute capabilities.

5. The method according to claim 1, wherein each feature of the first set of measurable features is a feature representing a property of a physical environment.

6. The method according to claim 5, wherein a feature representing a property of a physical environment is at least one of: temperature, light, acceleration, sound intensity, altitude, humidity, moisture, weather data, and positioning information.

7. The method according to claim 1, wherein the step of determining whether there is at least one sensor of the one or more sensors satisfying the associated measurement specification for collecting data corresponding to the feature further comprises adjusting a configuration of the at least one sensor of the one or more sensors to satisfy the feature's measurement specification.

8. The method according to claim 1, wherein the determining a first subset of the first set of measurable features further comprises at least one of:
determining that the number of features in the first subset of the first set of measurable features is maximized, with a constraint that a sum of the corresponding estimated resource usage is below a threshold value;
each feature of the first set of measurable features having a weight value indicating an importance of the feature, and determining that a sum of the corresponding estimated resource usage is weighted by the importance of each feature, with a constraint that the sum is below a threshold value.

9. The method according to claim 1, wherein the obtaining information from the coordinating computing device whether the client computing device belongs to a first group of computing devices of the plurality of computing devices further comprises: if the client computing device belongs to the first group of computing devices, obtaining information identifying a second subset of the first set of measurable features, wherein the second subset of the first set of measurable features have associated measurement specifications for collecting data corresponding to the features, and wherein the measurement specifications are satisfied by each of the first group of computing devices.

10. The method according to claim 9, wherein the method further comprises collecting data corresponding to the features of the second subset of the first set of measurable features based on the features' measurement specifications.

11. The method according to claim 1, wherein the obtaining information from the coordinating computing device whether the client computing device belongs to a first group of computing devices of the plurality of computing devices further comprises: if the client computing device does not belong to the first group of computing devices, obtaining information identifying a second set of measurable features, wherein the second set of measurable features have associated measurement specifications for collecting data corresponding to the features, and wherein the measurement specifications are satisfied by a second group of computing devices.

12. The method according to claim 11, wherein the method further comprises:
for each feature of the second set of measurable features, determining whether there is at least one sensor satisfying the feature's measurement specification for collecting data corresponding to the feature;
if there is at least one sensor satisfying the feature's measurement specification for collecting data corresponding to the feature, estimating a resource usage by each of the at least one sensor for collecting data corresponding to the feature; and
determining whether to collect data corresponding to the features of the second set of measurable features based on the estimated resource usage for collecting data corresponding to features of the second set of measurable features.

13. The method according to claim 12, wherein the determining whether to collect data corresponding to the features of the second set of measurable features further comprises: if a sum of the corresponding estimated resource usage is below a threshold value, collecting data corresponding to the features of the second set of measurable features based on the features' measurement specifications; and performing training of the machine learning model by the second group of computing devices.

14. The method according to claim 1, wherein the machine learning model is at least one of: a federated learning model, and a distributed collaborative learning model.

15. A method performed by a coordinating computing device of a plurality of computing devices configured to perform training of a machine learning model, the method comprising:
sending information identifying a first set of measurable features to a client computing device of the plurality of computing devices;
obtaining information identifying a first subset of the first set of measurable features from the client computing device, wherein the client computing device comprises one or more sensors, and the first subset of the first set of measurable features have associated measurement specifications for collecting data corresponding to the features, which measurement specifications are satisfied by at least one of the one or more sensors based on an estimated resource usage associated with the at least one of the one or more sensors;
determining if the client computing device belongs to a first group of computing devices based on the first subset of the first set of measurable features.

16. The method according to claim 15, wherein the sending information identifying a first set of measurable features to a client computing device further comprises sending a measurement specification for each feature of the first set of features.

17. The method according to claim 15, wherein the method further comprises: if the computing device does not belong to the first group of computing devices, sending information identifying a second set of measurable features, wherein the second set of measurable features have associated measurement specifications, which measurement specifications are satisfied by a second group of computing devices.

18. The method according to claim 15, wherein the method further comprises: if no group can be found for the client computing device, notifying the client computing device that it is not able to participate in training of the machine learning model.

19. The method according to claim 15, wherein the method further comprises: if the client computing device belongs to the first group of computing devices, sending information identifying a second subset of the first set of measurable features wherein the second subset of the first set of measurable features have associated measurement specifications, which measurement specifications are satisfied by each of the first group of computing devices.

20. A client computing device of a plurality of computing devices configured to perform training of a machine learning model, the client computing device comprising one or more sensors for collecting data, the client computing device comprising processing circuitry causing the computing device to be operative to:
obtain information identifying a first set of measurable features from a coordinating computing device of the plurality of computing devices, each feature of the first set of measurable features being associated with a measurement specification for collecting data corresponding to the feature;
for each feature of the first set of measurable features, determine whether there is at least one sensor of the one or more sensors satisfying the associated measurement specification for collecting data corresponding to the feature;
if there is at least one sensor of the one or more sensors satisfying the associated measurement specification, estimate a resource usage by each of the at least one sensor for collecting data corresponding to the feature;
determine a first subset of the first set of measurable features, wherein the at least one sensor of the one or more sensors is selected for collecting data corresponding to the first subset of the first set of measurable features based on the estimated resource usage;
send information identifying the first subset of the first set of measurable features to the coordinating computing device;
obtain information from the coordinating computing device whether the client computing device belongs to a first group of computing devices of the plurality of computing devices; and
if the client computing device belongs to the first group of computing devices, perform training of the machine learning model using the first group of computing devices.

21.-41. (canceled)
